(19) United States
(12) Patent Application Publication
(10) Pub. No.: US 2011/0163843 A1
(43) Pub. Date: Jul. 7, 2011

(54) MEDICATION CHAMBER LOCK FOR MEDICATION REMINDER DEVICE

(76) Inventor: Anthony Vallone, North Canton, OH (US)

(21) Appl. No.: 13/047,458

(22) Filed: Mar. 14, 2011

Related U.S. Application Data
(63) Continuation-in-part of application No. 11/712,376, filed on Feb. 28, 2007.

(51) Int. Cl. G08B 29/00; G06F 17/00; B65D 83/04

(52) U.S. Cl. 340/5.3; 700/237; 700/232; 340/5.2

(57) ABSTRACT

A medication reminder device may be programmed with a set of medication instructions comprising a medication regimen to be presented to an individual in order to promote compliance with a medication regimen, and may also include one or more medication chambers, each containing the medication doses of medications specified by a medication instruction. However, compliance with the medication regimen may nevertheless be reduced if the individual accesses a medication chamber in contravention of the medication regimen (e.g., due to an accident, a misunderstanding, an intentional misuse of the medication, or theft). Compliance with the medication regimen may be further improved by including a medication chamber lock that restricts access to a medication chamber, and a medication chamber lock controller that locks or unlocks the medication chamber lock in order to permit or restrict access to the medication doses of the medication contained therein according to the medication instructions.

### CROSS-REFERENCE TO RELATED APPLICATIONS

At least part of this patent application claims the benefit for priority, under 35 U.S.C. 120 and 37 C.F.R. §1.78, of U.S. application Ser. No. 11/712,376 “DEVICE FOR FACILITATING COMPLIANCE WITH MEDICATION REGIMEN”, filed on Feb. 28, 2007, which is incorporated by reference as if fully rewritten herein.

### BACKGROUND

The medical community notes that medication errors are a major reason for patient hospitalization, with mortality estimates sometimes reported as accounting for over 90,000 deaths per year. Although there are numerous factors contributing to this crisis, baselines in health-related information creation, transfer, comprehension, and compliance are key elements of this problem.

In efforts to address this problem, the medical community is embracing the advancement of computer-based systems. Although these systems are moving into the forefront, they may not be fully efficient or effective and may exhibit the same problems inherent in a paper-based system, including increased user entry and retrieval time in searching for current and historical health-related information. Both systems exhibit common problems by relying on text-based communication, which may be ambiguous, region-specific, and either partly or fully miscomprehended by people interacting with the system. These problems may be exacerbated or compounded during the transfer of health-related information among healthcare professionals, due to the lack of standardization (resulting in “re-entry” errors) and comprehension issues, where content of material and interpretation of health-related information is variable, based on organizational and cognitive abilities.

The transfer of health-related information between the medical community and the general population also continues to have serious problems, since non-standardized and often incomplete health-related information may be imperfectly “pieced together” by multiple healthcare providers and the patient to create an incorrect or incomplete medical record. This problem may also arise when health-related information (including the vehicle, route, dosage, time of day, administration, and/or use of a medication) is not easily transferred, accessed, or understood by the general population.

Additionally, noncompliance and abuse issues may arise in the community. For example, an individual may become confused as to the medication regimen and/or medication instructions, and, while attempting to fulfill a medication instruction, may consume the wrong medication, or the wrong dose of the correct medication. Alternatively, some medications may be abused by individuals in contravention of the medication regimen (e.g., the individual may intentionally consume too much medication, or may consume it too frequently), and/or may have value that encourages another individual to steal, access, and consume and/or distribute the medication to others.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The present disclosure relates to a medication device for communicating health-related information and for providing doses of medication in compliance with a medication regimen. Once a medication regimen has been formulated by a caregiver, the medication device is programmed with one or more medication instructions that comprise the medication regimen. The device may include a chronometer, by which it monitors time, and logic for determining when to generate medication reminder messages based on the chronometer and the medication instructions. For each medication instruction, and more specifically for each medication event corresponding to each medication instruction, the device generates a medication reminder message by displaying icons that are representative of the medication instruction. The medication device also features a medication chamber that contains a dose of the medication, and the medication reminder message may reference the medication chamber.

The presently disclosed techniques relate to securing the medication chamber with a locking mechanism that prevents or discourages access to the medication within a medication chamber except in compliance with the medication regimen. For example, the medication device may contain a medication that is to be taken under certain conditions (e.g., in small doses, at prescribed dates and times, or when the individual experiences particular symptoms). The medication device may include a controllable medication chamber lock that restricts physical access to the medication chamber, and a medication chamber lock controller that monitors the medication instructions and opens the medication chamber lock in accordance with a medication instruction. This securing of the medication chamber may improve the fulfillment of the medication regimen, e.g., by preventing the individual from taking the wrong medication or taking the medication under the wrong circumstances, and may prevent others to whom the medication has not been prescribed (e.g., children living in the home of the individual) from accessing the medication in an unauthorized manner.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 presents a component block diagram an exemplary medication reminder.

FIG. 2 presents an illustration of an exemplary medication reminder configured to present medication reminder messages using icons.

FIG. 3 presents an illustration of an exemplary medication reminder featuring one or more medication chambers respectively containing one or more medication doses of one or more medications specified by a medication instruction.

FIG. 4 presents an illustration of an exemplary medication reminder featuring a medication chamber lock configured to restrict access to medication doses of one or more medications contained in a medication chamber in accordance with the techniques presented herein.

FIG. 5 presents an illustration of a first exemplary medication chamber lock and medication chamber lock controller configured to restrict access to a medication dose of a medication contained in a medication chamber.

FIG. 6 presents an illustration of a second exemplary medication chamber lock and medication chamber lock controller configured to restrict access to a medication dose of a medication contained in a medication chamber.

FIG. 7 presents an illustration of a third exemplary medication chamber lock and medication chamber lock controller configured to restrict access to a medication dose of a medication contained in a medication chamber.

FIG. 8 presents an illustration of an exemplary scenario featuring a detection and reporting of tampering with a medication chamber lock.

FIG. 9 presents an illustration of an exemplary scenario featuring a detection of a physiological measurement of an individual accessing a medication chamber of a medication reminder device.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The present disclosure relates to the field of healthcare, and particularly to the formulation of a medication regimen by a caregiver for an individual. As a first example, the caregiver may comprise a physician, nurse, or other healthcare practitioner who formulates a medication regimen comprising one or more medications in order to prevent, address, and/or ameliorate a health condition of the individual. As a second example, the caregiver may comprise a nutritionist or other vitamin specialist who formulates a vitamin regimen comprising one or more vitamins in order to improve the general health of the individual.

In such scenarios, the preventative, curative, and/or palliative properties of the medication may be affected by the degree of compliance by the individual with the medication regimen. The compliance of the individual with the details of the medication regimen may be promoted through the use of a medication reminder device that is programmed with one or more mediation instructions of a medication regimen, and that may present to the individual a reminder message of a medication instruction. For example, the medication instructions may direct the individual to take one or more medication doses of one or more medications at a particular day or time, or upon experiencing a particular condition. However, the individual may have difficulty remembering the details of the medication instructions. For example, the individual may have low cognitive function or poor memory, and/or the medication regimen may be particularly extensive and/or complicated (e.g., a large number of medications to be taken at different times, in different ways, and/or under different circumstances).

Accordingly, compliance with the medication regimen may be promoted by programming one or more medication instructions comprising the medication regimen into a medication reminder device that the individual may carry and use to attend to the details of the medication regimen. For example, the medication reminder device may monitor the current date and time, and upon detecting a date and time specified by a medication instruction, may present the medication instruction to the individual. Moreover, the medication reminder device may present the medication instruction in various ways. For example, a set of icons may be devised that depict various aspects of a medication instruction (e.g., a color, size, and/or type of pill; a color and/or amount of a liquid; the date and/or time of the medication instruction; a manner of ingesting a type of medication; one or more conditions under which the medication is to be taken, such as with food; and/or a health condition that the medication is prescribed to address). The medication device may therefore present a medication instruction to the individual by selecting a set of icons that together depict the medication instruction. The use of pictorial icons may reduce errors in the communication of the medication regimen among one or more caregivers and the individual, and the compliance of the individual with the medication regimen. The medication reminder device may also utilize

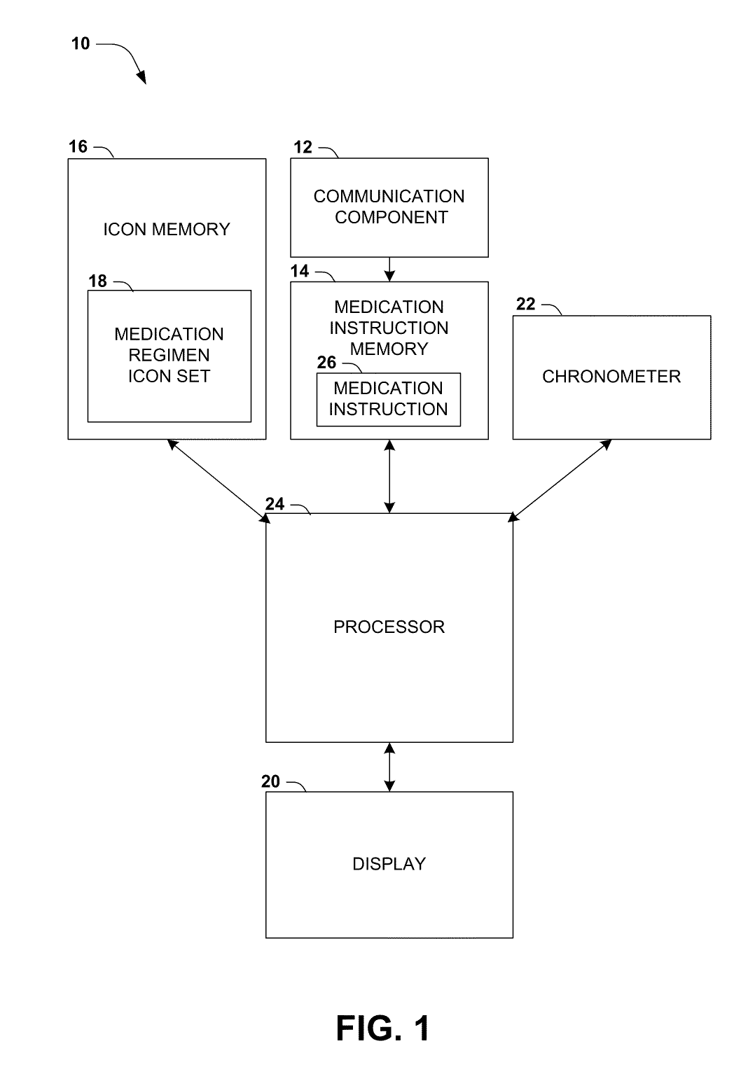

FIG. 1 presents an exemplary illustration of a medication reminder device configured device in accordance with the present disclosure. In this exemplary illustration, the medication reminder device 10 comprises an communication component 12 configured to receive medication instructions 26 comprising a medication regimen. The device also comprises a medication instruction memory 14, which is configured to store the medication instructions 26 received by the communication component 12, and an icon memory 16, which contains a medication regimen icon set 18. The device also comprises a display 20, such as an LCD, LED, projector, etc. The device also comprises a processor 24, which monitors the medication instructions 26 in the medication instruction memory 14 and generates a medication reminder message by displaying on the display 20 one or more icons selected from the medication regimen icon set 18 that together depict the medication instruction 26. The medication reminder device 10 also comprises a chronometer 22 and uses the information provided thereby to determine when to generate the reminder message(s) for each medication instruction 26. This information may either be precisely monitored and displayed, e.g., in accordance with an instruction to take a certain medication at 4:00 P.M., or may be more coarsely monitored to generate the medication reminder message in a broader time frame, e.g., in accordance with an instruction to take a certain medication in the evening.

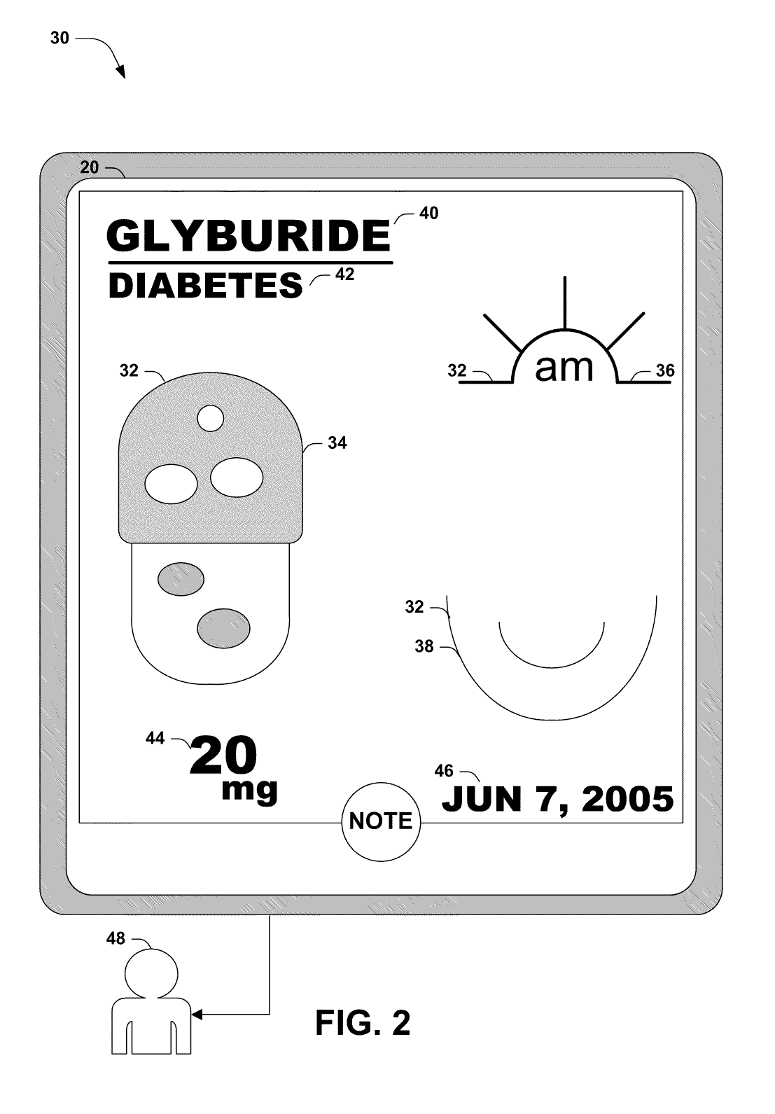

FIG. 2 illustrates a message that may be generated and presented by a medication reminder device 30 to indicate a medication instruction 26 to the individual 48 for whom the medication regimen has been prescribed. The medication reminder device 30 comprises a display 20 that displays to the individual 48 a medication reminder message through the presentation of a set of icons 32 that together depict the medication instruction 26. For example, the icons 32 may depict the medication 34 (e.g., a capsule), the time of day 36 in which the medication is to be taken (e.g., in the morning), and the method 38 by which the medication is to be taken (e.g., orally.) Information in the medication instruction 26 that is difficult to depict may be represented in text form, such as the name 40 of the medication 34, the condition that the medication 34 is prescribed to address 42, the dosage 44 of the medication 34, and the current date 46.

In addition to reminding an individual of a medication instruction 26, a medication reminder device 10 may also contain and/or administer medications 34 in compliance with a medication regimen. For example, the medication reminder device 10 may include a medication chamber that contains one or more doses of one or more medications 34, such as an enclosure containing one or more pills or a vial containing a liquid medication. In some embodiments, the medication reminder device 10 may include multiple medication chambers, each configured to store one or more medication doses of one or more medications 34, and an individual may be instructed to take all of the medication doses of medications in a particular medication chamber in compliance with a particular medication instruction 26. Moreover, a medication reminder device 10 may, while notifying an individual of a medication instruction, indicate to the individual which of the several medication chambers contains the medication 34 to be consumed.

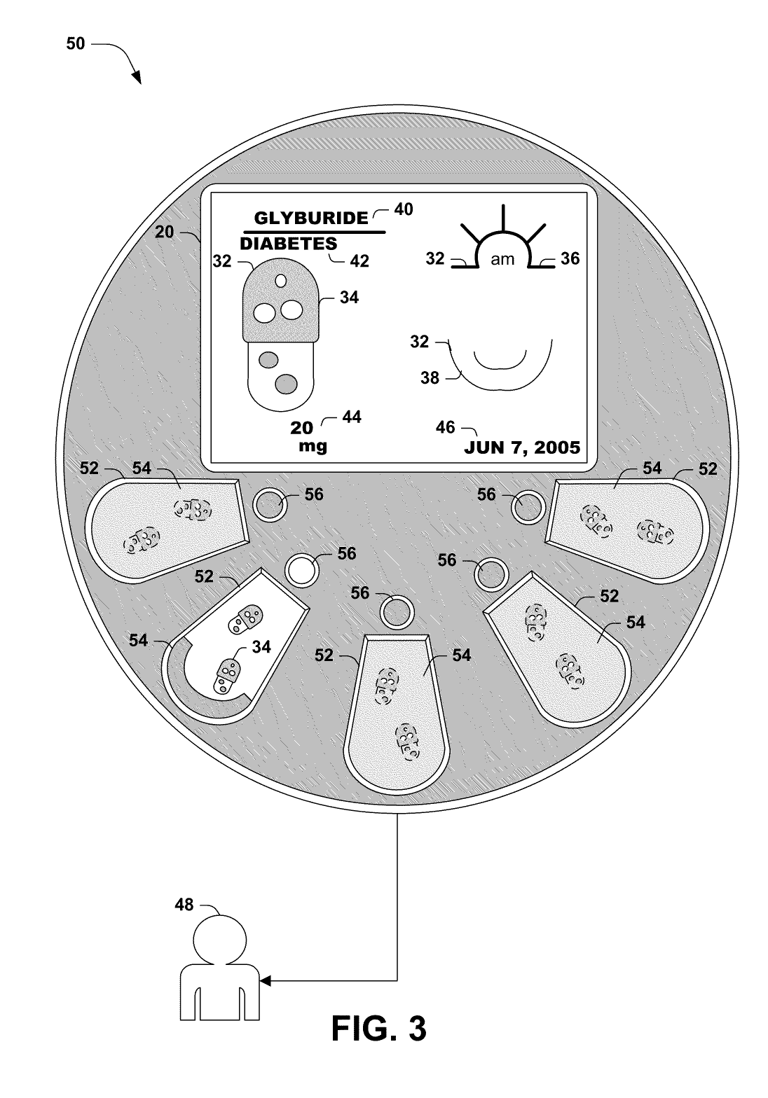

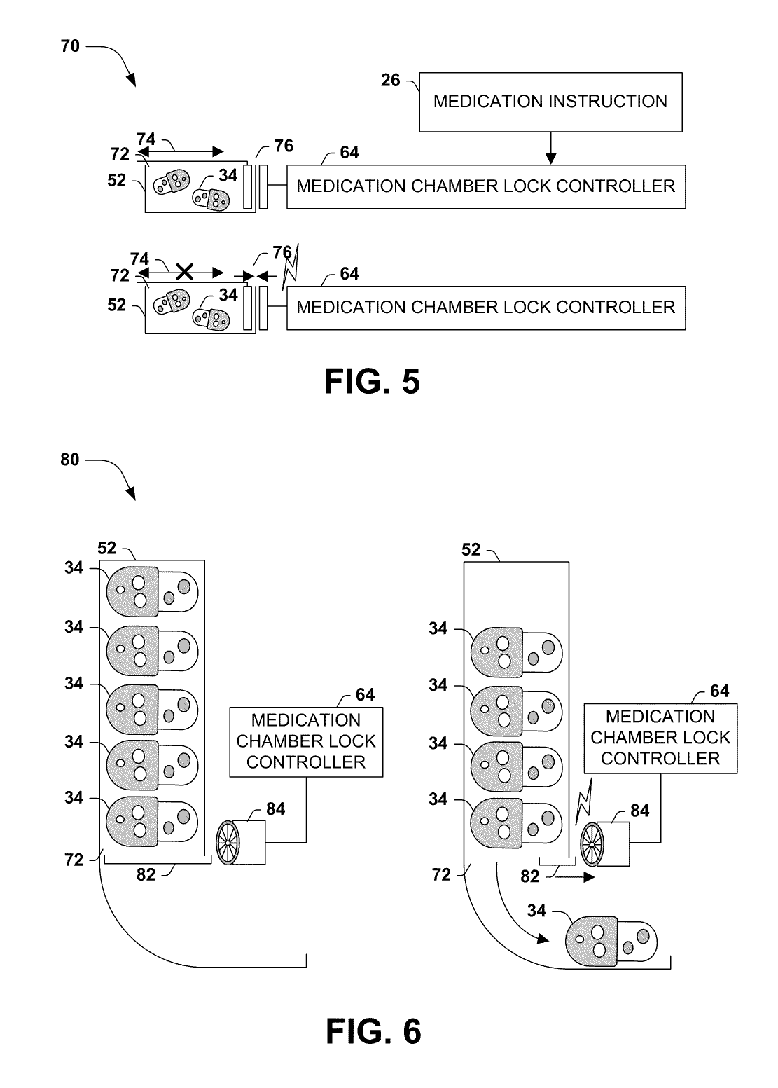

FIG. 3 presents an illustration of an exemplary medication reminder device 50 comprising a set of medication chambers 52, each configured to store one or more medication doses of one or more medications 34. The medication reminder device 50 is configured to store medication instructions 26 and to present on a display 20 a medication reminder message (e.g., by displaying a set of icons 32 that together depict the medication instruction 26). Additionally, the medication reminder device 50 comprises a set of medication chambers 52, each storing one or more medication doses of a medication 34 corresponding to a medication instruction 26. The medication reminder device 10 may comprise one medication chamber 52 storing one or more medication doses of a medication 34 (e.g., a bottle containing a large number pills), or (as illustrated in FIG. 5) two or more medication reminder chamber 52, each partitioned from the others and containing the medication doses of one or more medications 34 specified by a particular medication instruction 26. For example, respective partitioned medication reminder chambers 52 may include a cover 54 (such as a small door covering an aperture through a surface of the medication reminder device 50 and penetrating into the medication chamber 52), and the individual 48 may access the medication doses of the medication 34 by opening the cover 54 of a medication chamber 52. Moreover, the medication reminder device 50 may include a mechanism for identifying a particular medication chamber 52 containing the medication doses of the medication 34 specified by a presented medication instruction 26. For example, the exemplary medication reminder device 50 of FIG. 3 includes a visual indicator 56 (such as a small light source) for each medication chamber 52, and upon displaying a medication instruction 26 with respect to a particular medication chamber 52, the medication reminder device 50 may activate the visual indicator 56 (e.g., lighting the light source) to indicate the medication chamber 52 that the individual 48 is to access in order to comply with the medication regimen.

In this manner, the features of the exemplary medication reminders presented in FIGS. 1, 2, and 3 promote the compliance of an individual 48 with a medication regimen. However, this compliance may be complicated by several factors. As a first example, due to low cognitive function, confusion as to a medication instruction, or simple accident, an individual may incorrectly consume a dose of medication, such as taking too large a dose of the medication, taking the dose of medication at the wrong time or under the wrong circumstances, or accidentally consuming a first medication instead of a second medication. As a second example, some medications may have addictive effects, appealing side-effects, and/or off-label uses, and an individual may be compelled to consume the medication in contravention of the medication regimen. As a third example, some prescription medications may have significant value for other individuals, and a second individual may attempt to take the medication device away from the individual and then consume the medication and/or sell the medication to others.

In view of these considerations, it may be advantageous to configure an medication reminder device, in addition to presenting medication reminder messages representing respective medication instructions 26 (optionally through the presentation of icons 32) and present a medication chamber 52 containing medication doses of medications 34 specified by the medication instruction 26, to secure the medication chambers 52 in order to restrict access to the medication doses of the medications 34. For example, a medication reminder device 10 may include a medication chamber lock that restricts access to a medication chamber 52 containing a medication dose of a medication 34, and a medication chamber lock controller that controls the medication chamber lock (e.g., locking and unlocking the medication chamber lock) to restrict or permit access to the medication dose of the medication 34 in accordance with the medication instructions 26 of the medication regimen. The restriction of access to the medication 34, except as authorized by the medication instructions 26 of the medication regimen, may promote compliance of the individual 48 with the medication regimen and/or abuse of the medication 34 for unauthorized uses.

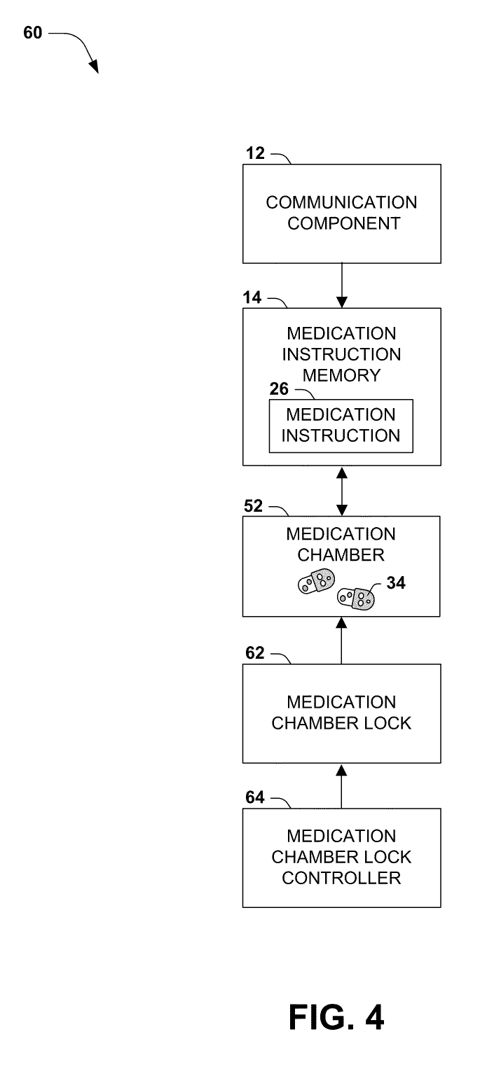

FIG. 4 presents an embodiment of these techniques, illustrated as a component block diagram of an exemplary device 60 that facilitates compliance with a medication regimen formulated by a caregiver for an individual 48. The exemplary device 60 may be implemented, e.g., as a system comprising a set of interoperating hardware components, as a software architecture comprising a set of software components (each implemented as a set of instructions stored in a memory component of the exemplary device 60, such as a memory circuit, a platter of a hard disk drive, a solid-state storage component, or a magnetic or optical disc) that, when executed on a processor of the exemplary device 60, interoperate to cause the hardware components exemplary device 60 to perform various aspects of the techniques presented herein), and/or a hybrid of hardware and software components. The exemplary device 60 comprises a communication component 12 that is configured to receive medication instructions 26 comprising the medication regimen. The exemplary device 60 also comprises a medication instruction memory 14 that is configured to store the medication instructions 26 comprising the medication regimen. The exemplary device 60 also comprises at least one medication chamber 52 that is configured to contain at least one medication dose of at least one medication 34 corresponding to a medication instruction 26. The exemplary device 60 also comprises at least one medication chamber lock 62 that is configured to restrict access to at least one medication chamber 52. The exemplary device 60 also comprises a medication chamber lock controller 64 that is configured to control the medication chamber lock 62 according to the medication instructions 26. By utilizing the components presented in FIG. 4 in an interoperating manner, the exemplary device 60 facilitates compliance of the individual 48 with the medication regimen by restricting access to the medication 34 stored in the medication chamber 52 except in compliance with the medication instructions 26 comprising the medication regimen.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 60 of FIG. 4) to confer individual and/or synergistic advantages upon such embodiments.

A first aspect that may vary among embodiments of the techniques presented herein relates to the scenarios wherein these techniques may be utilized. As a first example of this first aspect, the techniques may be utilized with many types of medication 34, which may be of many types (e.g., pills, tablets, capsules, powders, crystals, lotions, ointments, liquids, aerosols, or gases), and which may be dispensed and/or consumed in many ways (e.g., oral administration, topical application, inhalation, or intramuscular or intravenous injection). As a second example of this first aspect, the medication instructions 26 may be specified by many types of caregivers, such as a physician, nurse, pharmacist, or nutritionist, and/or may be specified by the individual 48 acting as his or her own caregiver. As a third example of this first aspect, these techniques may be incorporated within many types of medication reminder devices 10, including a portable device, a stationary device, or a software and/or hardware component configured for use with a portable or stationary device.

As a fourth example of this first aspect, the medication reminder device 10 may include many types of medication chambers 52, including a single compartment to hold many medication doses of one or more medications 34 allocated for one or more individuals 48; a set of segmented compartments, each holding a single medication dose of medication 34 corresponding to a medication instruction; a vial containing a liquid comprising multiple aliquots respectively corresponding to a medication dose of the medication; or a tank of a nebulizer configured to administer an aerosol or gaseous medication 34.

As a fifth example of this first aspect, the medication reminder device 10 may generate many types of medication reminders for respective medication instructions 26, including a depicted medication reminder (e.g., a displaying of icons depicting the medication instruction 34, such as depicted in FIG. 2), an alphanumeric medication reminder, an audible (e.g., spoken) medication reminder, a color-coded medication reminder, and/or a tactile medication reminder (e.g., utilizing heat or vibration to alert the individual 48). Those of ordinary skill in the art may devise many types of medication devices 10 wherein the techniques presented herein may be utilized.

A second aspect that may vary among embodiments of these techniques relates to the configuration of the medication chamber lock 62 to restrict access to a medication chamber 52. Those of ordinary skill in the art may devise many mechanisms that may restrict access to the medication chamber 52 in a reversible and controllable manner.

FIGS. 5, 6, and 7 present three examples of medication chamber locks 62 configured to restrict access to a medication chamber 52. The first exemplary scenario 70, illustrated in FIG. 5, presents a cross-sectional side view of a medication reminder device 10 featuring a medication chamber 52 containing a medication dose of a medication 34 comprises a physical enclosure, such as a box, with an aperture 72 through which the medication 34 may be removed. The aperture 72 is covered by a sliding door 74 that the individual 48 may open to access the medication chamber 52 or close to seal the medication chamber 52 (e.g., featuring a clasp [not illustrated] that holds the sliding door 74 in a closed position unless manipulated by the individual 48). This exemplary scenario 70 illustrates the implementation of a medication chamber lock 62 in the form of a latch 76 that, when engaged, secures the sliding door 74 in a closed position. The latch 76 is implemented as a magnet attached to the right side of the sliding door 74, and a controllable electromagnet attached outside the right wall of the physical enclosure comprising the medication chamber 52. When activated, the electromagnet may attract the magnet attached to the sliding door 74, thereby restricting the movement of the sliding door 74 in a closed position and sealing the medication chamber 52. The electromagnet is controlled by the medication chamber lock controller 64, which may power the electromagnet to activate the latch 76 and lock the medication chamber 52, and/or remove power from the electromagnet to deactivate the latch 76 and unlock the medication chamber 52. For example, in the upper illustration, the medication chamber 62, in compliance with a medication instruction 26, removes power from the latch 76 to unlock the medication chamber lock 62, permitting the sliding door 74 to be retracted, the aperture 72 to be opened, and the medication 34 to be accessed. By contrast, in the lower illustration, the medication chamber 62, in the absence of a medication instruction 26, applies power to the latch 76 to lock the medication chamber lock 62, restricting the sliding door 74 from being retracted, thereby sealing the aperture 72 and obstructing access to the medication 34.

FIG. 6 illustrates a second exemplary scenario 80 presenting a cross-sectional side view of a medication reminder device 10 featuring a medication chamber 52 configured to dispense medication doses of a medication 34 (e.g., dispensing one capsule in accordance with a medication instruction 26). In this second exemplary scenario 80, the dispenser comprises a medication chamber 52, and a medication chamber lock 62 may be operated to dispense medication 34 from the medication chamber 52 (which is otherwise sealed). For example, the bottom of the medication chamber 52 may feature an aperture 72 that is ordinarily blocked by a retractable floor 82 that may be retracted to release a medication dose of the medication 34 (e.g., one capsule). The retractable floor 82 may be held in a closed position (e.g., by a spring) unless retracted by a motor 84, which operates as the medication chamber lock 62 in this second exemplary scenario 80. The motor 84 may be controlled by a medication chamber lock controller 64, such that, in a locked position (as presented in the left illustration of FIG. 6), the retractable floor 82 remains closed; but when activated by a medication chamber lock controller 64 in compliance with a medication instruction 26 (as presented in the right illustration of FIG. 6), the motor 84 may engage the retractable floor 82 to permit a medication dose of the medication to escape the medication chamber 52.

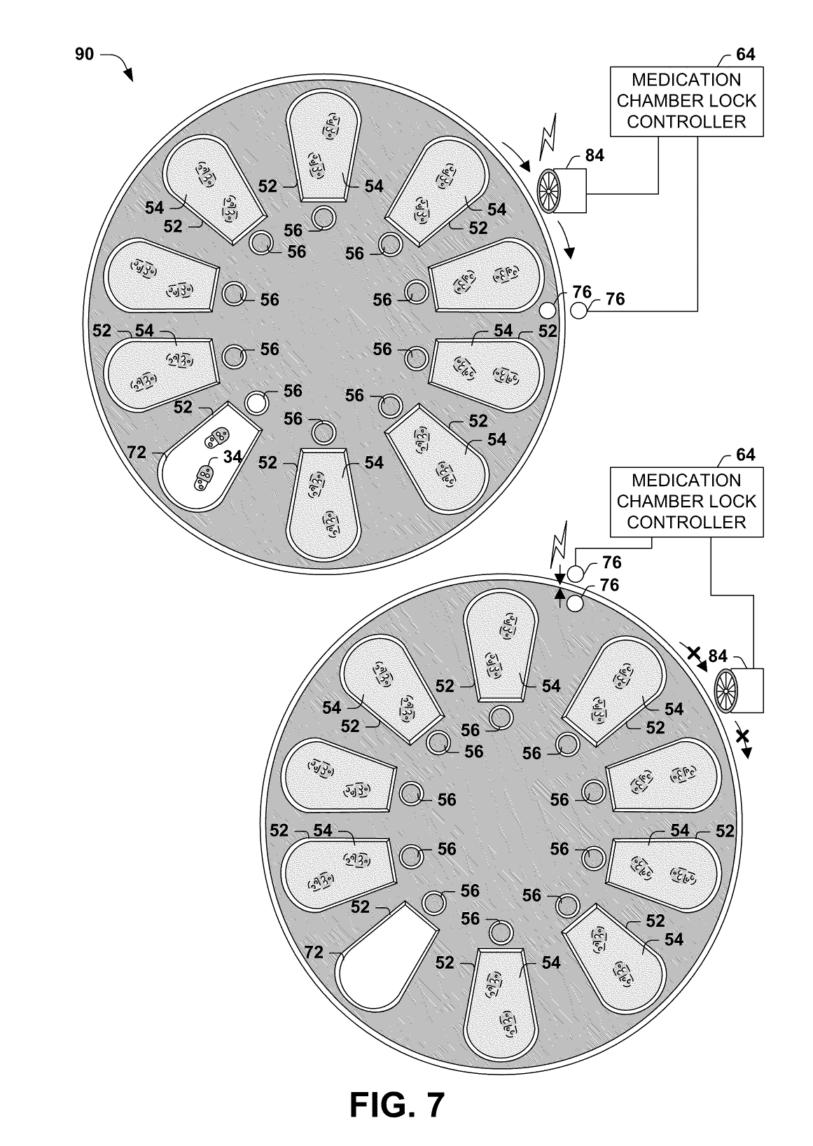

FIG. 7 illustrates a third exemplary scenario 90 presenting a top view of a medication reminder device 10 featuring a medication chamber 52 configured to dispense medication doses of a medication 34 (e.g., dispensing one capsule in accordance with a medication instruction 26). In this third exemplary scenario 90, the medication reminder device 10 comprises a round palette having a body featuring radially arranged plurality of medication chambers 52 comprising pits or recessions in the body of the medication reminder device 10 and a rotatable top surface featuring an aperture 72. The rotatable top surface provides a cover 54 that overlaps each medication chamber 52 that is not aligned with and exposed by the aperture 72. The top surface rotatable by a motor 84 comprising the medication chamber lock 62. For example, a medication chamber lock controller 64, in accordance with a medication instruction 26, may provide power to the motor 84 to engage and rotate the top surface in order to align the aperture 72 with a corresponding medication chamber 52, thereby exposing the medication dose of the medication 34 contained therein (such as presented in the top illustration of FIG. 7). However, the top surface is not manually rotatable, and may physically resist manual rotation. For example, the medication chamber lock 72 may also be implemented as a latch 76, such as a magnet embedded in the top surface and an electromagnet embedded on a lateral surface of the body of the round palette. In the absence of a medication instruction 26, the medication chamber lock controller 64 may power the electromagnet to create a magnetic force attracting the magnet embedded in the body of the round palette, thereby physically resisting a rotational force applied to the round palette.

A comparison of the implementations of the medication chamber lock 62 in the exemplary scenarios of FIGS. 5, 6, and 7 may indicate some variations of this second aspect. As a first example of this first aspect, the medication chamber lock 62 may utilize many types of electrical, mechanical, and/or physical mechanisms restrict access to the medication chamber 52 in many ways, including a closing, obstruction, or shrinking of an aperture or a locking of a movable part such as a dispenser. Additional mechanisms for restricting access to the medication 34 may also be devised, such as a removal of the medication 34 from the medication chamber 52; a fixation of the medication 34 within the medication chamber 52; or a physical or psychological deterrent (e.g., a mechanism that renders the medication unusable if removed in an unauthorized manner). As a second example of this second aspect, a medication chamber lock 52 may secure various numbers of medication chambers 52 and/or medication doses of medications 34. As a first variation, a medication chamber lock 62 may secure one medication chamber 52 storing medication doses of medications 34 specified by one medication instruction 26 (such as in the exemplary first scenario 70 of FIG. 5. As a second variation, a medication device 10 may comprise two or more medication chambers 52 and two or more medication chamber locks 62, each medication chamber lock 62 securing one medication chamber 52 (e.g., a plurality of medication chambers 52 and medication chamber locks 62 illustrated in the first exemplary scenario 70 of FIG. 5). As a third variation, the medication chamber lock 52 may secure a medication chamber 52 storing many medication doses of medications 34 specified by two or more medication instructions 26 (such as in the second exemplary second scenario 80 of FIG. 6). As a fourth variation, a medication chamber lock 62 may secure two or more medication chambers 52. Moreover, the medication chamber lock may participate in the dosing of the medication 34, e.g., by permitting access to a medication dose of a medication 34 in accordance with a medication instruction 26, while restricting access to the remaining medication doses of the medication 34 that are not specified by the medication instruction 26 (such as in the exemplary third scenario 90 of FIG. 7).

As a third example of this second aspect, in addition to permitting access to medication 34 in accordance with medication instructions 26, medication chamber lock 62, medication chamber lock controller 64, and/or a medication reminder device 10 may be configured to permit or restrict access to the medication chambers 26 based on other considerations. As a first variation, the medication chamber lock may comprise an active lock that, when activated, permits access to the medication chamber 52 unless disabled by the medication chamber lock controller, or a passive lock that, when activated, obstructs access to the medication chamber 52 unless disabled by the medication chamber lock controller to remove the obstruction and permit access to the medication chamber 52. This design choice may be significant, e.g., in view of a medication device 10 having a power source, such as a battery or an electrical outlet, that the medication chamber lock controller 64 utilizes to control the medication chamber lock 62. For example, when sufficient power is provided, the medication chamber lock controller 64 may function properly to permit and restrict access according to medication instructions 26; but a medication chamber lock 62 may be configured to, upon losing power from the power source (e.g., when the battery is exhausted and/or the device is unplugged from an electrical outlet) and entering an unpowered state, may either permit access to the medication chamber 52 (a “default open” configuration, such as an electromagnet that holds a latch closed when powered), or restrict access to the medication chamber (a “default closed” configuration, such as a medication chamber lock 62 that retracts a sliding door 74 that is otherwise held closed by a spring). Different implementations may be advantageous for different scenarios. For medication 34 that is vital to the health of the individual 48 (e.g., nitroglycerin provided to regulate the heart of the individual 48), a “default open” configuration may be advantageous, since restricting access to the medication 34 in the event of a loss of power may be dangerous to the health of the individual 48. However, for medication 34 that is not vital to the health of the individual 48 but may be abused by the individual 48 (e.g., medication with physically and/or psychologically addictive properties and a potential for abuse and overdose), a “default closed” configuration may be advantageous, since a “default open” configuration permits the individual 48 to gain access to the medication 34 simply by depleting the battery and isolating the medication reminder device 10 from other power sources.

As a second variation of this third example of this second aspect, the medication chamber lock controller 64 may permit authorized individuals to access to the medication chamber 52 in order to manage the contents of the medication reminder device 10 on behalf of the individual 48, such as permitting a caregiver or pharmacist to examine, fill, remove, and/or change the contents of the medication device 10. For example, the medication chamber lock controller 64 may be configured to, upon receiving a key, permit access to a medication chamber 52. The key may comprise, e.g., a physical key inserted into a physical lock, a virtual key such as a password or authenticating certificate, or a biometric key, such as an identifying physical feature of the caregiver (e.g., a thumbprint) that may be detected, evaluated, and identified by a biometric sensor.

As a third variation of this third example of this second aspect, the medication chamber lock controller 64 may simply permit the individual 48 to request access to the medication chamber 52. For example, the communication component 12 of a medication reminder device 10 may receive a request from the individual 48 to access a medication dose of a medication 34 stored in a medication chamber 52, such as a medication dispensed on an “as needed” basis. In some embodiments, the medication chamber lock controller 64 may evaluate the request of the individual 48, and, in some circumstances, may unlock the medication chamber lock 62 to permit access to the medication chamber 52. This variation may be advantageous, e.g., for permitting access to an “as needed” medication 34, but only within dosing limitations, and/or for permitting access to a medication 34 but also recording each request for reporting to the caregiver (thus, only restricting access to the medication chamber 52 with the medication chamber lock 62 in the absence of a recordable request by the individual 48). As another example, the medication reminder device 10 may submit the request to the caregiver, and may only unlock the medication chamber lock 62 to permit access to the medication chamber 64 upon receiving from the caregiver an approval in response to the request. Those of ordinary skill in the art may devise many designs of the medication chamber lock 62 and/or medication chamber lock controller 64 for inclusion in a medication reminder device 10 in accordance with the techniques presented herein.

A third aspect that may vary among embodiments of these techniques relates to a detection of tampering with the medication reminder device 10, such as an unauthorized attempt to access a medication chamber 52. As a first example, a medication reminder device 10 may comprise a medication chamber tamper detector that is configured to detect an unauthorized access by the individual 48 of a medication chamber 52 that is not authorized by a medication instruction 26. Upon the medication chamber tamper detector detecting an unauthorized access, the communication component may notify an individual (e.g., notifying the individual 48 that access is not permitted, or notifying another individual, such as a physician, nurse, pharmacist, parent, or police agency of the attempt to access the medication 34 in a noncompliant manner). For example, the medication chamber tamper detector may be configured to detect a physical gap in an aperture 72, a reduction of mass in the medication chamber 52, or the presence of light in an ordinarily opaque medication chamber 52 despite the locking of a medication chamber lock 62.

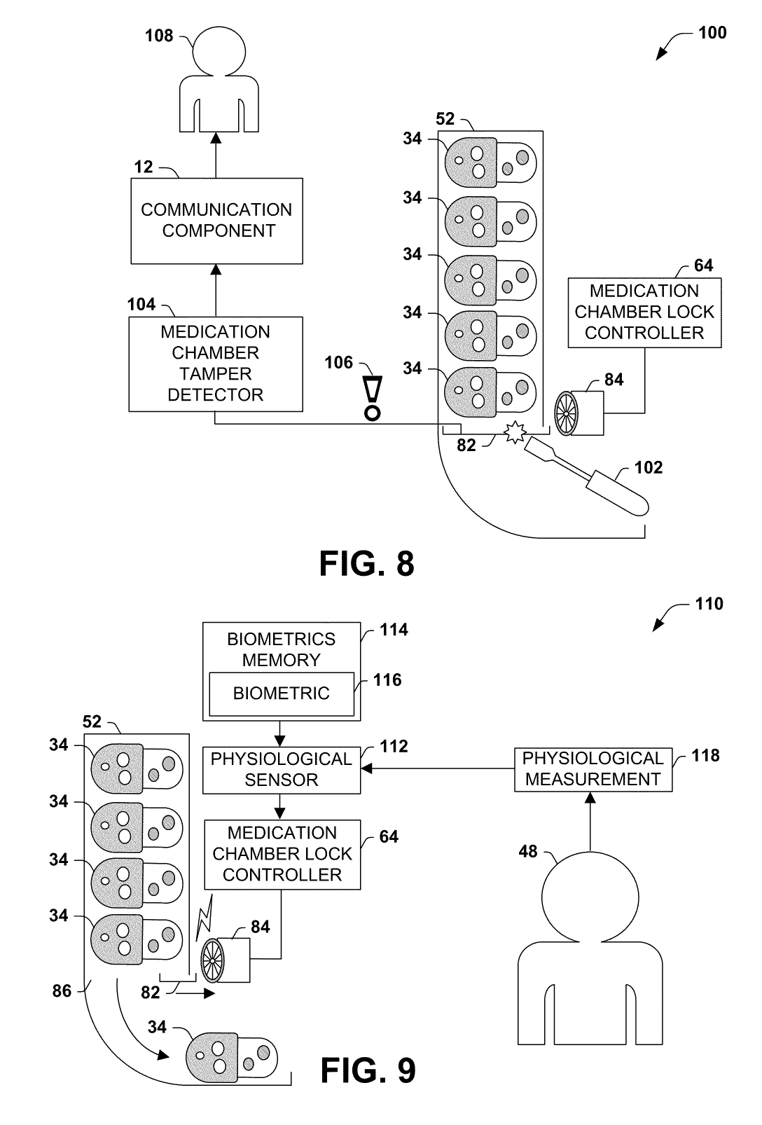

FIG. 8 presents an illustration of an exemplary scenario 100 featuring a medication chamber tamper detector 104 that is operably coupled with a medication chamber 52 of a medication reminder device 10 comprising a dispenser. The medication chamber lock controller 64 of this medication reminder device 10 dispenses medication doses of the medication 34 in accordance with medication instructions 26 by retracting a sliding door 82. However, in this exemplary scenario 100, the individual 48 performs an unauthorized access attempt 102 to access the medication chamber 52, e.g., attempting to pry the sliding door 82 open with a screwdriver. The medication chamber tamper detector 104 may be configured to monitor the medication chamber 52, may detect 106 the unauthorized access attempt 102, and may, using the communication component 12, notify a caregiver 108 of the unauthorized access attempt 102. In this manner, attempts to extract medication 34 in a noncompliant manner (according to the medication regimen) may be detected and reported to a caregiver.

As a second example of this third aspect, the unauthorized attempt 102 to access a medication chamber 52 of the medication reminder device 10 may be due simply to an error on the part of the individual 48. Specifically, in the context of a medication reminder device 10 having at least two medication chambers 52, a medication instruction 26 may permit the individual 48 to access a first medication chamber 52, but the individual 48 may erroneously attempt to access a second medication chamber 52. Accordingly, if a medication chamber tamper detector detects an unauthorized access of the second medication chamber 52, the communication component may notify the individual 48 of the error, e.g., by indicating the first medication chamber 52 specified by the medication instruction 26 instead of the second medication chamber 52.

As a third example of this third aspect, the medication chamber tamper detector may simply detect a request by the individual 48 to access a medication chamber 48 that is not authorized by any medication instruction 26 of the medication regimen. The medication reminder device 10 may simply notify the individual 48 that access is restricted. Alternatively, the medication chamber lock controller 64 may consider the request, e.g., by evaluating at least one access consideration, to determine whether to permit access to the medication dose of the medication 34 contained in the medication chamber 52. Exemplary access considerations include a medication type access consideration (e.g., considering the type of medication 34 to which the individual 48 has requested access); a health condition of the individual for which the medication doses of the medication 34 have been formulated by the caregiver (e.g., the severity of the health condition, and the value of contravening the medication regimen in view of a health emergency); a physiological measurement of the individual 48 (e.g., detecting that the individual 48 is in stress or pain before releasing an anti-anxiety or analgesic medication 34); an environmental factor of an environment of the device (e.g., whether the individual 48 resides with or without children who may be tampering with the medication reminder device 10); and a medication regimen history of the medication regimen of the individual 48 (e.g., prior administration of medication doses of the medication 34 to the individual 48, and/or whether the individual 48 has a history of abusing this or other medications 34). Those of ordinary skill in the art may devise many ways of detecting, reporting, and responding to tampering with a medication reminder device 10 while implementing the techniques presented herein.

A fourth aspect that may vary among embodiments of these techniques relates to the detection of physiological measurements of the individual 48 in relation to the control of a medication chamber lock 62 by a medication chamber lock controller 64. As a first example, the medication regimen many have been formulated by a caregiver in view of a health condition of the individual 48. Moreover, the health condition may be detected by physiological measurements, such as a heart condition detected by evaluating the cardiac rhythm of the individual 48; a fever detected by evaluating the temperature of the individual 48; and a diabetic condition detected by evaluating the blood sugar level of the individual 48. Accordingly, the medication reminder device 10 may include one or more physiological sensors (e.g., a heart monitor, a thermometer, or a blood glucose monitor) that is configured to detect a physiological measurement of the individual relating to the health condition, and the medication reminder device 10 (and in particular the medication chamber lock controller 64) may use the physiological measurement in relation to a medication instruction 26.

As a first example of this fourth aspect, a medication instruction 26 may condition a medication dose of a medication 34 upon the physiological measurement; e.g., upon the physiological sensor detecting a heart arrhythmia, the medication chamber lock controller 64 may unlock the medication chamber lock 62 of a medication chamber 52 containing a nitroglycerin tablet to alleviate the heart arrhythmia. As a second variation of this fourth aspect, the medication instruction 26 may adjust the dose of a medication according to the physiological measurement (e.g., a fever reducing medication may be dispensed in a variable amount based on the severity of the fever indicated by a detected temperature of the individual 48), and the medication chamber lock controller 64 may accordingly adjust the medication dose of the medication 34 unlocked by the medication chamber lock 62 (e.g., controlling the medication chamber lock 62 to dispense a variable number of capsules in the second exemplary scenario 80 of FIG. 6, or unlocking a variable number of medication chamber locks 62 for a variable number of medication chambers 52 in the third exemplary scenario 90 of FIG. 7).

As a third example of this fourth aspect (and alternatively or additionally with the other examples), the physiological measurement may be utilized as a biometric to authenticate the identity of the individual 48 as a condition of permitting access to a medication chamber 52. For example, the medication reminder device 10 may comprise a biometrics memory storing at least one biometric that identifies the individual 48, such as a characteristic of a fingerprint. The medication chamber lock controller 64 may, upon notifying the individual 48 of a medication instruction 26, request the individual to submit a biometric measurement to the physiological sensor to verify the identity of the individual 48 before unlocking the medication chamber lock 62 to dispense the medication 34.

FIG. 9 presents an illustration of an exemplary scenario 110 featuring an authentication of an individual 48 as a condition of dispensing a medication dose of a medication 34. In this exemplary scenario 110, the medication device 10 includes a physiological sensor 112, which is configured to detect physiological measurements 118 of an individual 48, as well as a biometrics memory 114 storing one or more biometrics 116 that identify one or more individuals 48. In accordance with a medication instruction 26 of the medication regimen, the medication reminder device 10 may present a reminder message to the individual 48, but may also ask the individual 48 to submit a physiological measurement 118 to the physiological sensor 112. Upon receiving the physiological measurement of the individual 48, the medication chamber lock controller 64 and/or physiological sensor may compare the physiological measurement 118 with the biometric 116 stored in the biometrics memory 114 in order to identify and authenticate the individual 48, and may unlock the medication chamber lock 62 (e.g., activating a motor 84 to dispense a medication dose of the medication 34) only if the physiological measurement 118 corresponds to a biometric 116 authenticating the identity of the individual 48.

As a fourth example of this fourth aspect (and alternatively or additionally with the other examples), physiological measurements 118 detected by a physiological sensor 112 may be recorded in a physiological measurement memory. This variation may be advantageous, e.g., for detecting physiological measurements 118 and/or periodically recording the physiological state and/or health condition of the individual 48. If the physiological measurement 118 is captured for other uses when the individual 48 is taking medication 34 in accordance with a medication instruction 26 (e.g., identifying a status of the health condition of the individual 48 in order to assess the need and/or dosage of a medication 34), it may be additionally convenient to record the physiological measurement 48 as part of the electronic medical record of the individual 48. Those of ordinary skill in the art may devise many uses of the physiological measurements detected by a physiological sensor in conjunction with a medication chamber lock controller 64 included in a medication reminder device 10 in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

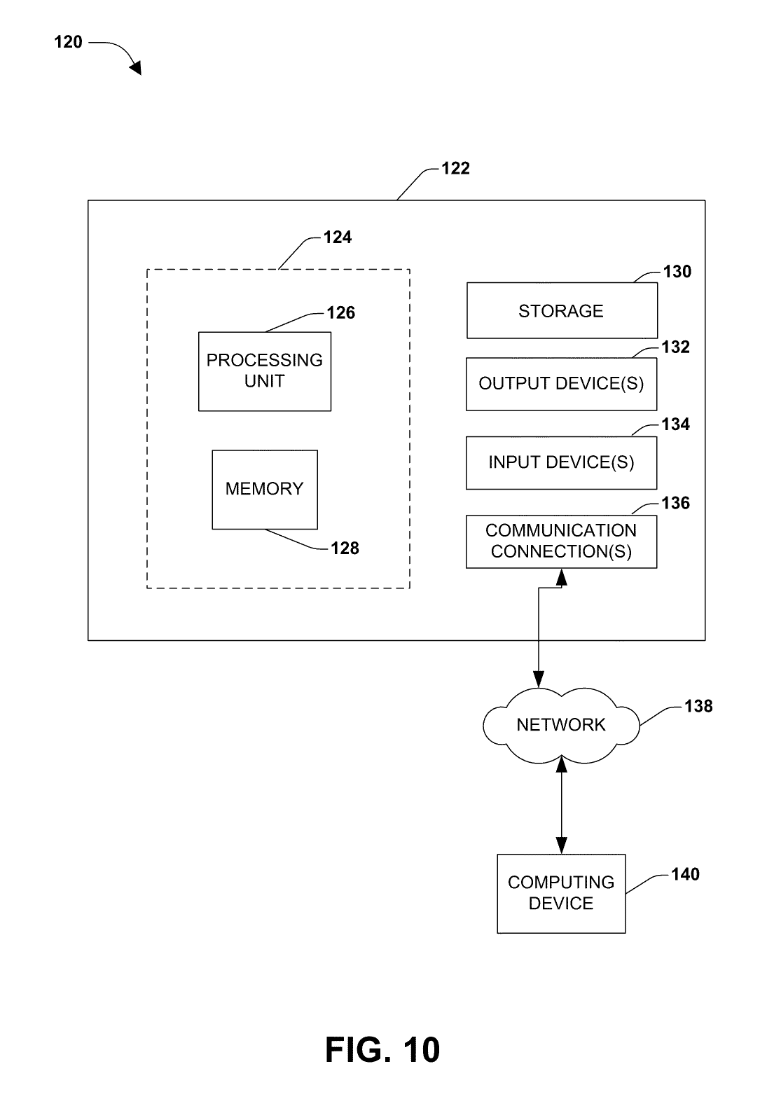

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 120 comprising a computing device 122 configured to implement one or more embodiments provided herein. In one configuration, computing device 122 includes at least one processing unit 126 and memory 128. Depending on the exact configuration and type of computing device, memory 128 may be volatile (such as RAM, for example), non-volatile (such as ROM, flash memory, etc., for example) or some combination of the two. This configuration is illustrated in FIG. 10 by dashed line 124.

In other embodiments, device 122 may include additional features and/or functionality. For example, device 122 may also include additional storage (e.g., removable and/or non-removable) including, but not limited to, magnetic storage, optical storage, and the like. Such additional storage is illustrated in FIG. 10 by storage 130. In one embodiment, computer readable instructions to implement one or more embodiments provided herein may be in storage 130. Storage 130 may also store other computer readable instructions to implement an operating system, an application program, and the like. Computer readable instructions may be loaded in memory 128 for execution by processing unit 126, for example.

The term “computer readable media” as used herein includes computer storage media. Computer storage media includes volatile and nonvolatile, removable and non-removable media implemented in any method or technology for storage of information such as computer readable instructions or other data. Memory 128 and storage 130 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 122. Any such computer storage media may be part of device 122.

Device 122 may also include communication connection(s) 136 that allows device 122 to communicate with other devices. Communication connection(s) 136 may include, but is not limited to, a modem, a Network Interface Card (NIC), an integrated network interface, a radio frequency transmitter/receiver, an infrared port, a USB connection, or other interfaces for connecting computing device 122 to other computing devices. Communication connection(s) 136 may include a wired connection or a wireless connection. Communication connection(s) 136 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 122 may include input device(s) 134 such as keyboard, mouse, pen, voice input device, touch input device, infrared cameras, video input devices, and/or any other input device. Output device(s) 132 such as one or more displays, speakers, printers, and/or any other output device may also be included in device 122. Input device(s) 134 and output device(s) 132 may be connected to device 122 via a wired connection, wireless connection, or any combination thereof. In one embodiment, an input device or an output device from another computing device may be used as input device(s) 134 or output device(s) 132 for computing device 122.

Components of computing device 122 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 122 may be interconnected by a network. For example, memory 128 may be comprised of multiple physical memory units located in different physical locations interconnected by a network.

Those skilled in the art will realize that storage devices utilized to store computer readable instructions may be distributed across a network. For example, a computing device 140 accessible via network 138 may store computer readable instructions to implement one or more embodiments provided herein. Computing device 122 may access computing device 140 and download a part or all of the computer readable instructions for execution. Alternatively, computing device 122 may download pieces of the computer readable instructions, as needed, or some instructions may be executed at computing device 122 and some at computing device 140.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A device for facilitating compliance with a medication regimen formulated by a caregiver for an individual, comprising:
a communication component configured to receive medication instructions comprising the medication regimen;
a medication instruction memory configured to store the medication instructions;
at least one medication chamber configured to contain at least one medication dose of at least one medication corresponding to a medication instruction;
a medication chamber lock configured to restrict access to the medication chamber; and
a medication chamber lock controller configured to control the medication chamber lock according to the medication instructions.

2. The device of claim 1, comprising:
a display;
an icon memory comprising at least one icon depicting an aspect of a medication instruction; and
a medication reminder component configured to, for respective medication instructions, generate a medication reminder message by displaying on the display icons selected from the icon memory that together depict the medication instruction.

3. The device of claim 1, the device comprising:
at least two medication chambers respectively containing at least one medication dose of at least one medication; and
at least two medication chamber locks respectively configured to restrict access to one medication chamber.

4. The device of claim 1:
the medication chamber comprising at least two medication doses of at least one medication;
at least one medication instruction specifying at least one dose of the medication; and
the medication chamber lock configured to restrict access to the medication doses of the at least one medication that are not specified by the medication instruction.

5. The device of claim 1:
the device comprising a power source configured to power the medication chamber lock; and
the medication chamber lock controller configured to, upon losing power from the power source, lock the medication chamber lock to restrict access to the medication chamber.

6. The device of claim 1:
the device comprising a power source configured to power the medication chamber lock; and
the medication chamber lock controller configured to, upon losing power from the power source, unlock the medication chamber lock to permit access to the medication chamber.

7. The device of claim 1, the medication chamber lock controller configured to, upon receiving a key, unlock the medication chamber lock to permit access to the medication chamber.

8. The device of claim 1, comprising: a medication chamber tamper detector configured to detect an unauthorized access by the individual of a medication chamber that is not authorized by a medication instruction.

9. The device of claim 8, the communication component configured to notify an individual upon detecting the unauthorized access by the individual of the medication chamber.

10. The device of claim 9:
the device comprising at least two medication chambers;
the unauthorized access of a second medication chamber detected while a medication instruction specifies at least one medication dose of at least one medication contained in a first medication chamber; and
the communication component configured to notify the individual of the medication instruction specifying the at least one medication dose of the at least one medication contained in the first medication chamber instead of the second medication chamber.

11. The device of claim 8:
the medication chamber lock controller configured to, upon the medication chamber tamper detector detecting the unauthorized access:
evaluate at least one access consideration to determine whether to permit access to the at least one medication dose of the at least one medication contained in the medication chamber; and
upon determining to permit access to the medication chamber, unlock the medication chamber lock to permit access to the medication chamber.

12. The device of claim 11, the at least one access consideration selected from an access consideration set comprising:
a medication type access consideration of the medication doses of the medication contained in the medication chamber;
a health condition of the individual for which the medication doses of the medication have been formulated by the caregiver;
at least one physiological measurement of the individual;
at least one environmental factor of an environment of the device; and
a medication regimen history of the medication regimen of the individual.

13. The device of claim 1:
at least one medication instruction of the medication regimen formulated by the caregiver for a health condition of the individual; and
the device comprising: at least one physiological sensor configured to detect, in relation to a medication instruction, at least one physiological measurement of the individual related to the health condition.

14. The device of claim 13, comprising: a physiological measurement memory configured to store physiological measurements detected by the physiological sensor.

15. The device of claim 13, at least one medication instruction conditioning at least one medication dose of at least one medication upon the physiological measurement of the individual.

16. The device of claim 15, the medication instruction adjusting at least one medication dose of at least one medication upon the physiological measurement.

17. The device of claim 13:
the device comprising: a biometrics memory configured to store at least one biometric identifying the individual; and
the medication chamber lock controller configured to, before releasing the medication chamber lock to dispense a medication dose, authenticate the individual by comparing at least one physiological measurement with the at least one biometric stored in the biometrics memory and identifying the individual.

18. The device of claim 1:
the communication component configured to receive a request from the individual to dispense at least one medication dose of at least one medication; and
at least one medication instruction specifying at least one medication dose of at least one medication to be dispensed upon the request of the individual.

19. The device of claim 18:
the communication component configured to send the request to the caregiver; and
the medication chamber lock controller configured to, upon the communication component configured to receive from the caregiver an approval in response to the request, unlock the medication chamber lock to permit access to the medication chamber.

20. A device for facilitating compliance with a medication regimen formulated by a caregiver for a health condition of an individual, the device comprising:
a medication instruction memory configured to store medication instructions;
at least two medication chambers respectively configured to contain at least one medication dose of at least one medication corresponding to a medication instruction;
for respective medication chambers, a medication chamber lock configured to restrict access to the medication chamber;
a medication chamber tamper detector configured to detect an unauthorized access by the individual of a medication chamber that is not authorized by a medication instruction;
a medication chamber lock controller configured to:
control the medication chamber locks according to the medication instructions; and
upon receiving a key, unlock the medication chamber locks to permit access to the medication chambers;
upon the medication chamber tamper detector detecting the unauthorized access:
evaluate at least one access consideration to determine whether to permit access to the at least one medication dose of the at least one medication contained in the medication chamber; and
upon determining to permit access to the medication chamber, unlock the medication chamber lock to permit access to the medication chamber;
a communication component configured to:
receive medication instructions comprising the medication regimen, and
notify an individual upon detecting the unauthorized access by the individual of the medication chamber;
at least one physiological sensor configured to detect, in relation to a medication instruction, at least one physiological measurement of the individual related to the health condition;
a physiological measurement memory configured to store physiological measurements detected by the at least one physiological sensor;
a power source configured to power the medication chamber locks;
a display;
an icon memory comprising at least one icon depicting an aspect of a medication instruction; and
a medication reminder component configured to, for respective medication instructions, generate a medication reminder message by displaying on the display icons selected from the icon memory that together depict the medication instruction and the medication chamber containing the at least one medication dose of the at least one medication specified by the medication instruction.
